(19) United States
(12) Patent Application Publication
(10) Pub. No.: US 2025/0148757 A1
(43) Pub. Date: May 8, 2025

(54) SELF-IMPROVING DATA ENGINE FOR AUTONOMOUS VEHICLES

(71) Applicant: NEC Laboratories America, Inc., Princeton, NJ (US)

(72) Inventors: Jong-Chyi Su, San Francisco, CA (US); Sparsh Garg, Fremont, CA (US); Samuel Schulter, Long Island City, NY (US); Manmohan Chandraker, Santa Clara, CA (US); Mingfu Liang, Evanston, IL (US)

(21) Appl. No.: 18/931,681

(22) Filed: Oct. 30, 2024

Related U.S. Application Data
(60) Provisional application No. 63/595,471, filed on Nov. 2, 2023.
(60) Provisional application No. 63/599,538, filed on Nov. 15, 2023.

(51) Int. Cl. G06V 10/764; B60W 60/00; G06T 11/00; G06V 10/25; G06V 10/44; G06V 10/74; G06V 20/70

(52) U.S. Cl. CPC G06V 10/764; B60W 60/001; G06T 11/00; G06V 10/25; G06V 10/44; G06V 10/761; G06V 20/70

(57) ABSTRACT

Systems and methods for a self-improving data engine for autonomous vehicles is presented. To train the self-improving data engine for autonomous vehicles (SIDE), multi-modality dense captioning (MMDC) models can detect unrecognized classes from diversified descriptions for input images. A vision-language-model (VLM) can generate textual features from the diversified descriptions and image features from corresponding images to the diversified descriptions. Curated features, including curated textual features and curated image features, can be obtained by comparing similarity scores between the textual features and top-ranked image features based on their likelihood scores. Generate annotations, including bounding boxes and labels, can be generated for the curated features by comparing the similarity scores of labels generated by a zero-shot classifier and the curated textual features. The SIDE can be trained using the curated features, annotations, and feedback.

### RELATED APPLICATION INFORMATION

This application claims priority to U.S. Provisional App. No. 63/595,471, filed on Nov. 2, 2023, and U.S. Provisional App. No. 63/599,538, filed on Nov. 15, 2023, incorporated herein by reference in their entirety.

### BACKGROUND

### Technical Field

The present invention relates to optimizing computer vision artificial intelligence models and more particularly to a self-improving data engine for autonomous vehicles.

### Description of the Related Art

Artificial intelligence (AI) models have improved dramatically over the years especially in entity detection, scene reconstruction, anomaly detection, trajectory generation, and scene understanding. However, the accuracy of the AI models are directly proportional to the quality of data that they are trained with. Thus, improving the quality of training data for the AI models is an important issue that still needs to be addressed for AI models.

### SUMMARY

According to an aspect of the present invention, a computer-implemented method for training a self-improving data engine for autonomous vehicles (SIDE) is provided, including, detecting unrecognized classes from diversified descriptions for input images generated using a multi-modality dense captioning (MMDC) model, generating, with a vision-language-model (VLM), textual features from the diversified descriptions and image features from corresponding images to the diversified descriptions, obtaining curated features, including curated textual features and curated image features, by comparing similarity scores between the textual features and top-ranked image features based on their likelihood scores, generating annotations, including bounding boxes and labels, for the curated features by comparing the similarity scores of labels generated by a zero-shot classifier and the curated textual features, and training the SIDE using the curated features, annotations, and feedback.

According to another aspect of the present invention, a system for training a self-improving data engine for autonomous vehicles (SIDE), including, a memory device, one or more processor devices operatively coupled with the memory device to detect unrecognized classes from diversified descriptions for input images generated using a multi-modality dense captioning (MMDC) model, generate, with a vision-language-model (VLM), textual features from the diversified descriptions and image features from corresponding images to the diversified descriptions, obtain curated features, including curated textual features and curated image features, by comparing similarity scores between the textual features and top-ranked image features based on their likelihood scores, generate annotations, including bounding boxes and labels, for the curated features by comparing the similarity scores of labels generated by a zero-shot classifier and the curated textual features, and training the SIDE using the curated features, annotations, and feedback.

According to yet another aspect of the present invention, a non-transitory computer program product is provided including a computer-readable storage medium having program code for training a self-improving data engine for autonomous vehicles (SIDE), wherein the program code when executed on a computer causes the computer to detect unrecognized classes from diversified descriptions for input images generated using a multi-modality dense captioning (MMDC) model, generate, with a vision-language-model (VLM), textual features from the diversified descriptions and image features from corresponding images to the diversified descriptions, obtain curated features, including curated textual features and curated image features, by comparing similarity scores between the textual features and top-ranked image features based on their likelihood scores, generate annotations, including bounding boxes and labels, for the curated features by comparing the similarity scores of labels generated by a zero-shot classifier and the curated textual features, and training the SIDE using the curated features, annotations, and feedback.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram illustrating a high-level overview of a computer-implemented method for training a self-improving data engine for autonomous vehicles, in accordance with an embodiment of the present invention;

FIG. 2 is a block diagram illustrating a system for a self-improving data engine for autonomous vehicles, in accordance with an embodiment of the present invention;

FIG. 3 is a block diagram illustrating a system showing a software implementation of a self-improving data engine for autonomous vehicles (SIDE), in accordance with an embodiment of the present invention;

FIG. 4 is a block diagram showing a system that implements a practical application of the self-improving data engine for autonomous vehicles, in accordance with an embodiment of the present invention; and

FIG. 5 is a block diagram illustrating deep learning neural networks for a self-improving data engine for autonomous vehicles, in accordance with an embodiment of the present invention.

### DETAILED DESCRIPTION OF PREFERRED EMBODIMENTS

In accordance with embodiments of the present invention, systems and methods are provided for a self-improving data engine for autonomous vehicles.

In an embodiment, a method for training a self-improving data engine for autonomous vehicles is presented. To train the self-improving data engine for autonomous vehicles (SIDE), multi-modality dense captioning (MMDC) models can detect unrecognized classes from diversified descriptions for input images. A vision-language-model (VLM) can generate textual features from the diversified descriptions and image features from corresponding images to the diversified descriptions. Curated features, including curated textual features and curated image features, can be obtained by comparing similarity scores between the textual features and top-ranked image features based on their likelihood scores. Generate annotations, including bounding boxes and labels, can be generated for the curated features by comparing the similarity scores of labels generated by a zero-shot classifier and the curated textual features. The SIDE can be trained using the curated features, annotations, and feedback.

In an embodiment, the trained SIDE can be employed to generate trajectories for simulated traffic scenes that includes the curated features and annotations to control an autonomous vehicle. The simulated traffic scenes can be used to verify the accuracy of the SIDE and to continuously train the SIDE with feedback regarding the simulated traffic scenes.

Developing robust perception models for autonomous driving is challenging, particularly when it comes to identifying rare or unseen objects on the road. Given the limited availability of data, these models often struggle to detect such categories, even though their detection is crucial for ensuring road safety.

Currently, adapting the model to recognize unseen objects necessitates the collection of data and human annotations, a process that is both costly and inefficient. In particular, the procedure involves the selection of images that potentially contain rare objects from an extensive database of video footage. These chosen images are subsequently forwarded for human annotation to obtain precise bounding boxes. Finally, the model is trained using the curated data and annotations. The entire workflow demands a substantial amount of human effort for data curation and annotation, making it non-scalable.

To enhance the scalability and efficiency of the data curation and annotation process, the present embodiments propose a fully automated pipeline that eliminates the need for human involvement. Specifically, the present embodiments harness the power of large vision-language models (VLMs) to oversee data curation and annotation. The present embodiments can generate descriptions of the category. Subsequently, the present embodiments employ these descriptions to query images using VLMs, and without human intervention, the present embodiments utilize the VLMs to auto-label these images. These auto-generated labels, often referred to as pseudo-labels, are then employed to fine-tune the model. This process enables the model to detect previously unseen categories or enhance the robustness of rare categories.

By continuously training the SIDE with new images and feedback, the SIDE can more accurately and quickly detect previously unrecognized classes thus, improving the accuracy of the vision-language-models for object detection.

The present embodiments present an automated data curation step, which significantly reduces the number of images required for subsequent processes. This not only enhances the pipeline's efficiency but also minimizes false positives during the auto-labeling phase

The present embodiments also implement a robust auto-labeling step. Conventional auto-labeling methods often struggle to generate pseudo-labels for rare or unseen categories, as they rely on models with moderate class prediction capabilities. To overcome this limitation, the present embodiments can use Vision-Language Models (VLMs) to guide the auto-labeling process. VLMs, having been trained on extensive datasets of image-text pairs, is capable of identifying if objects are in an image given descriptions. In summary, the present embodiments harness VLMs to streamline data curation and labeling, eliminating the need for human intervention.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer-readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random-access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

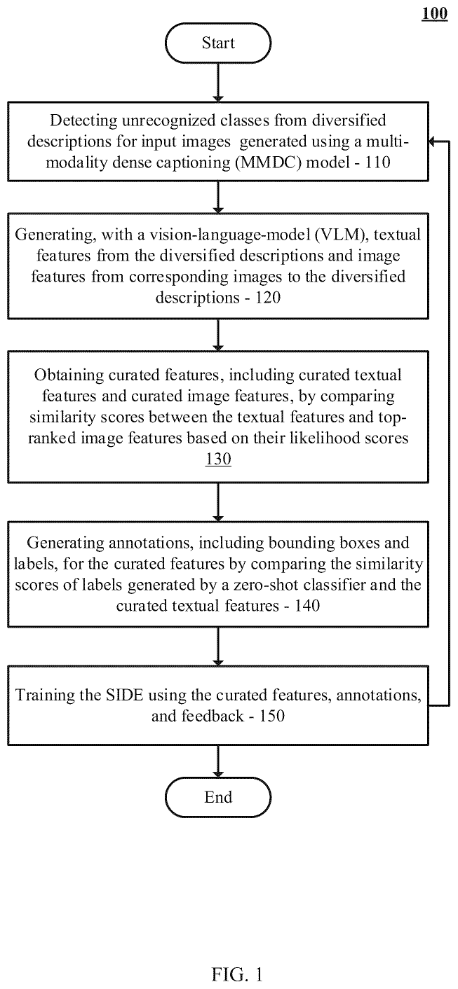

Referring now in detail to the figures in which like numerals represent the same or similar elements and initially to FIG. 1, a high-level overview of a computer-implemented method for training a self-improving data engine for autonomous vehicles is illustratively depicted in accordance with one embodiment of the present invention.

In an embodiment, a method for training a self-improving data engine for autonomous vehicles is presented. To train the self-improving data engine for autonomous vehicles (SIDE), multi-modality dense captioning (MMDC) models can detect unrecognized classes from diversified descriptions for input images. A vision-language-model (VLM) can generate textual features from the diversified descriptions and image features from corresponding images to the diversified descriptions. Curated features, including curated textual features and curated image features, can be obtained by comparing similarity scores between the textual features and top-ranked image features based on their likelihood scores. Generate annotations, including bounding boxes and labels, can be generated for the curated features by comparing the similarity scores of labels generated by a zero-shot classifier and the curated textual features. The SIDE can be trained using the curated features, annotations, and feedback.

In an embodiment, the trained SIDE can be employed to generate trajectories for simulated traffic scenes that includes the curated features and annotations to control an autonomous vehicle. The simulated traffic scenes can be used to verify the accuracy of the SIDE and to continuously train the SIDE with feedback regarding the simulated traffic scenes.

Referring now to block 110 of FIG. 1 showing an embodiment of a method of detecting unrecognized classes from diversified descriptions for the input images generated using multi-modality dense captioning (MMDC) models.

Unrecognized classes can include object classifiers that are rarely encountered in a traffic scene and new classes that are not included in the known label space of SIDE. The rarity of the classes can be determined based on the number of times the class has been encountered by SIDE.

Diversified descriptions can include texts describing objects in various scenarios, which can include diverse road scenes and various appearances for the objects. For example, a diversified description can include “The image shows a busy city street with cars and bicyclists sharing the road. A traffic light is visible on the right side of the image, controlling the flow of vehicles and bicycles.”

The MMDC models such as Otter™M are trained with several million multi-modal in-context instruction tuning datasets which can provide fine-grained and comprehensive descriptions of a scene context. Other MMDC models can be employed.

To detect the unrecognized classes, an unlabeled image from the input image can pass to an object detector model to obtain a list of predicted categories and the MMDC model to obtain diversified descriptions within the image. By comparing the diversified descriptions and the predicted categories with a text processor, the unrecognized classes can be detected as the predicted categories that are not included in the diversified descriptions.

Referring now to block 120 of FIG. 1 showing an embodiment of a method of generating, with a vision-language-model (VLM), textual features from the diversified descriptions and image features from corresponding images to the diversified descriptions.

The textual features can be obtained from the diversified descriptions that are relevant to the unrecognized classes. In the example above, the word “bicyclists” can be the unrecognized class. The textual features can include tokens that has a semantic relationship with “bicyclists,” such as “sharing the road,” “cars,” and “busy city street.” The textual features can be combined to generate a prompt using a prompt template. For example, the prompt can be: “An image containing bicyclists sharing the busy city street with cars.”

The image features can be objects within a generated photorealistic synthetic images that align with the textual features image using the prompt and the VLM. The image feature can include a bounding box, object attributes, category label, and likelihood score of containing the category label, etc. In the example above, the image features can include a bicyclist, the bicycle, the road, etc.

The VLM can be a bootstrapping language-image pre-training-2 (BLIP-2), contrastive language-image pre-training (CLIP), etc. Other VLMs can be used.

Referring now to block 130 of FIG. 1 showing an embodiment of a method of obtaining curated features, including curated textual features and curated image features, by comparing similarity scores between the textual features and top-ranked image features based on their likelihood scores.

The textual features and the image features are curated. To curate the image features, the top-ranked image features based on their likelihood scores are selected. For each top-ranked image feature, textual features are curated based on their similarity with each other. The similarity can be computed as cosine similarity between the embeddings of the textual features and the image features from the VLM. The textual features and the image features having the highest cosine similarity will be grouped together to obtain curated features. Further, duplicates from the curated features, such as neighboring video frames, can be removed.

Referring now to block 140 of FIG. 1 showing an embodiment of a method of generate annotations, including bounding boxes and labels, for the curated features by comparing the similarity scores of labels generated by a zero-shot classifier and the curated textual features.

To generate annotations for the curated features, region proposal networks (RPN) can be employed to localize generic objects and detect object features from the image that includes the curated image features. The RPN can be pretrained with a closed-set label space. Additionally, open vocabulary detectors (OVD) can be employed to perform text-guided localizations for the detected objects using the curated textual features. The OVD can be pretrained on web-scale datasets.

The localized objects can include bounding box proposals and pseudo-labels. The pseudo-labels generated from the first iteration of filtering using the OVD can be filtered based on the noise generated by the OVD by performing zero-shot classification on the localized objects.

To perform zero-shot classification, localized objects and their bounding box proposals are masked from the generated image to obtain masked box proposals. The masked box proposals can be fed into a zero-shot classifier for zero shot classification (ZSC) to obtain labels and corresponding bounding boxes. The zero-shot classifier can be an open vocabulary detector such as CLIP. A base label space can be created that includes the curated image features and the curated textual features, combined with label spaces from existing datasets such as autonomous vehicle datasets, to include everyday objects likely present on road scenes.

The curated textual features and the labels generated by the zero-shot classifier can be grouped based on calculated similarity score (e.g., cosine similarity) from respective embeddings of the curated textual features and the labels to obtain annotations. In another embodiment, human annotators can verify the labels for the bounding boxes.

Referring now to block 150 of FIG. 1 showing an embodiment of a method of training the SIDE using the curated features, annotations, and feedback.

The curated features, annotations, and feedback can be used to continuously train the SIDE. To continuously train, past knowledge is retained while training with new data. To retain previously learned knowledge, pseudo-labels for known categories are generated and mixed with the new data while training. To obtain the pseudo-labels for known categories, an object detector can be used to infer data and obtain pseudo-label proposals. The pseudo-label proposals are filtered based on the predicted confidence score and the highest pseudo-label proposals are selected to be applied to OVD to generate the pseudo-labels for known categories.

New data for continuously training the SIDE can be obtained by generating trajectories within a traffic scene simulation generated by the SIDE. The trajectories can be used to control an autonomous vehicle. The traffic scene simulation generated by the SIDE can be used to verify whether the trained SIDE can now detect the unrecognized classes within the curated features. New unrecognized classes can be detected from the traffic scene simulation generated by the SIDE. In another embodiment, the training can be stopped after reaching a training threshold. The training threshold can be a natural number such as five, ten, twenty, etc.

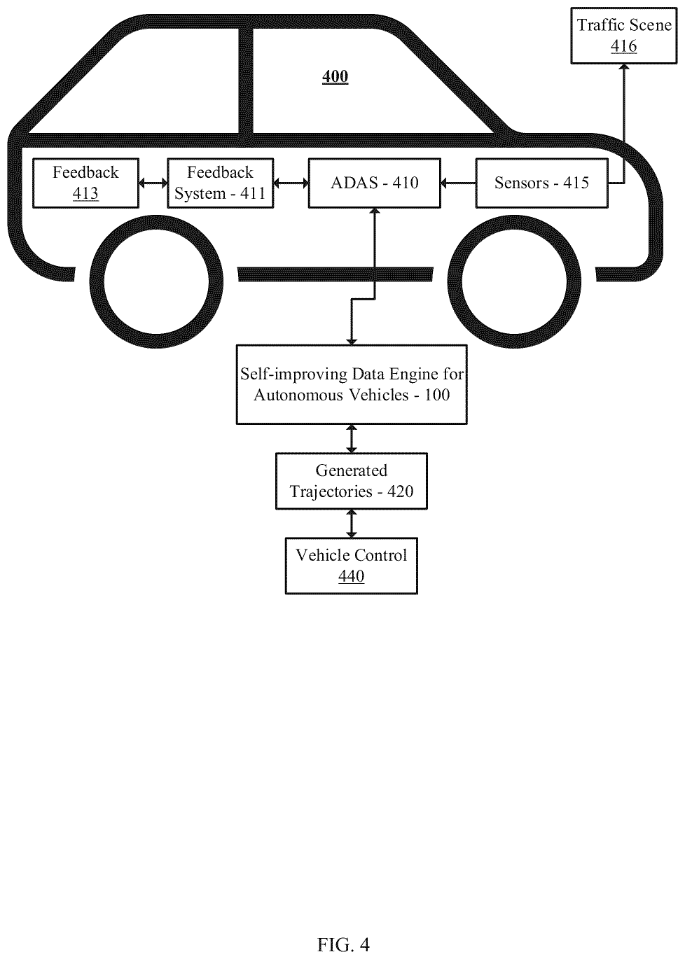

New unrecognized classes can also be detected from input images taken in the real world through sensors. This is shown in more detail in FIG. 4.

Referring now to FIG. 4 showing a system that implements a practical application of the self-improving data engine for autonomous vehicles, in accordance with an embodiment of the present invention.

Autonomous vehicle 400 can include sensors 415, advanced driver assistance system (ADAS) 410 and feedback system 411. The sensors 415 can include light detection and ranging (LiDAR) sensors, cameras, microphones, etc. The sensors 415 can collect data from the traffic scene 416 which can include unrecognized classes. The feedback system 411 can include a display, and an input mechanism (e.g., keyboard, touch, microphone, etc.) that shows a query to a decision-making entity that can provide feedback 413. The feedback system 411 can connect to a network that can communicate with experts that can provide feedback 413. The feedback 413 can include object data for the unrecognized classes such as bounding boxes, labels, etc. The experts can be a large VLM or MMDC that can provide synthesized images of ground truth data which can correspond to unrecognized classes within a traffic scene 416.

The ADAS 410 can include the computing system 200 that implements the self-improving data engine for autonomous vehicles 100. The computing system 200 can generate generated trajectories 420 for the traffic scene 416 that can be performed by the autonomous vehicle. The generated trajectory 420 can include vehicle control 440 such as braking, speeding up, changing direction, etc.

In another embodiment, the computing system 200 can be deployed in a different analytical server which can communicate with the vehicle 400 through a network. In another embodiment, the sensors 415 can be separate from the autonomous vehicle 400 and can send the traffic scene 416 to the computing system 200 through a network. The network can include a cloud computing environment. Other network implementations can be employed.

The autonomous vehicle 400 can include motorized entities such as cars, trucks, drones, boats, etc.

In another embodiment, the self-improving data engine for autonomous vehicles 100 can be implemented in other systems that are not autonomous vehicles such as equipment management systems (e.g., performs a corrective action based on a detected anomaly, or unrecognized class), person detection systems (e.g., detects an unrecognized person within a specific location), etc. Other practical applications are contemplated.

By continuously training the SIDE with new images and feedback, the SIDE can more accurately and quickly detect previously unrecognized classes thus, improving the accuracy of the vision-language-models for object detection.

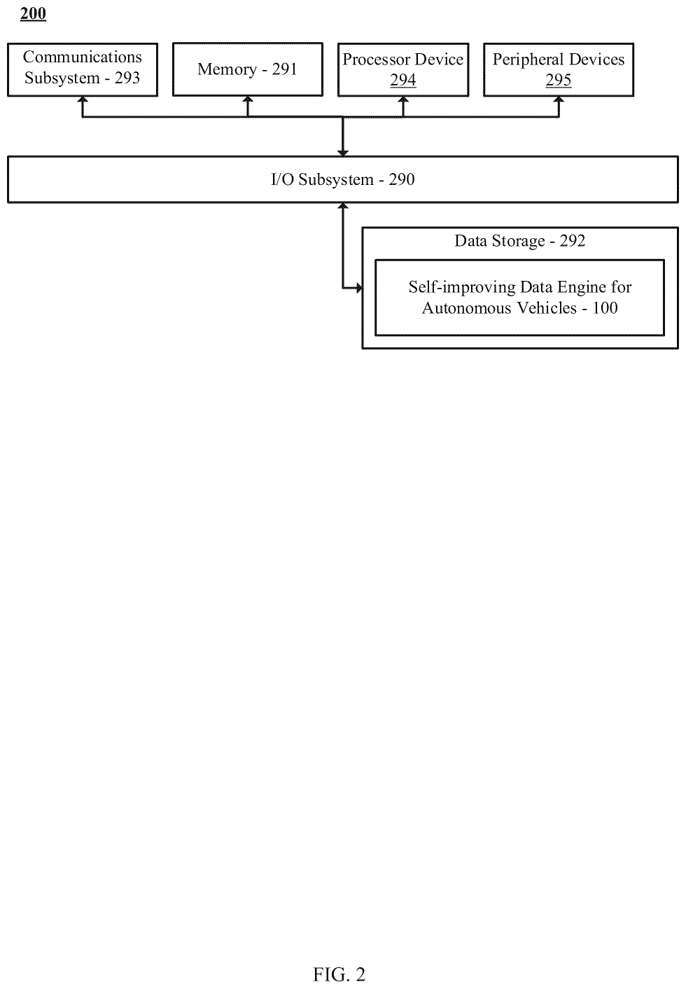

Referring now to FIG. 2, a system for a self-improving data engine for autonomous vehicles is illustratively depicted in accordance with an embodiment of the present invention.

The computing device 200 illustratively includes the processor device 294, an input/output (I/O) subsystem 290, a memory 291, a data storage device 292, and a communication subsystem 293, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 291, or portions thereof, may be incorporated in the processor device 294 in some embodiments.

The processor device 294 may be embodied as any type of processor capable of performing the functions described herein. The processor device 294 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 291 may be embodied as any type of volatile or non-volatile memory or data storage capable of performing the functions described herein. In operation, the memory 291 may store various data and software employed during operation of the computing device 200, such as operating systems, applications, programs, libraries, and drivers. The memory 291 is communicatively coupled to the processor device 294 via the I/O subsystem 290, which may be embodied as circuitry and/or components to facilitate input/output operations with the processor device 294, the memory 291, and other components of the computing device 200. For example, the I/O subsystem 290 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 290 may form a portion of a system-on-a-chip (SOC) and be incorporated, along with the processor device 294, the memory 291, and other components of the computing device 200, on a single integrated circuit chip.

The data storage device 292 may be embodied as any type of device or devices configured for short-term or long-term storage of data such as, for example, memory devices and circuits, memory cards, hard disk drives, solid state drives, or other data storage devices. The data storage device 292 can store program code for self-improving data engine for autonomous vehicles 100. Any or all of these program code blocks may be included in a given computing system.

The communication subsystem 293 of the computing device 200 may be embodied as any network interface controller or other communication circuit, device, or collection thereof, capable of enabling communications between the computing device 200 and other remote devices over a network. The communication subsystem 293 may be configured to employ any one or more communication technology (e.g., wired or wireless communications) and associated protocols (e.g., Ethernet, InfiniBand®, Bluetooth®, Wi-Fi®, WiMAX, etc.) to affect such communication.

As shown, the computing device 200 may also include one or more peripheral devices 295. The peripheral devices 295 may include any number of additional input/output devices, interface devices, and/or other peripheral devices. For example, in some embodiments, the peripheral devices 295 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing system 200 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

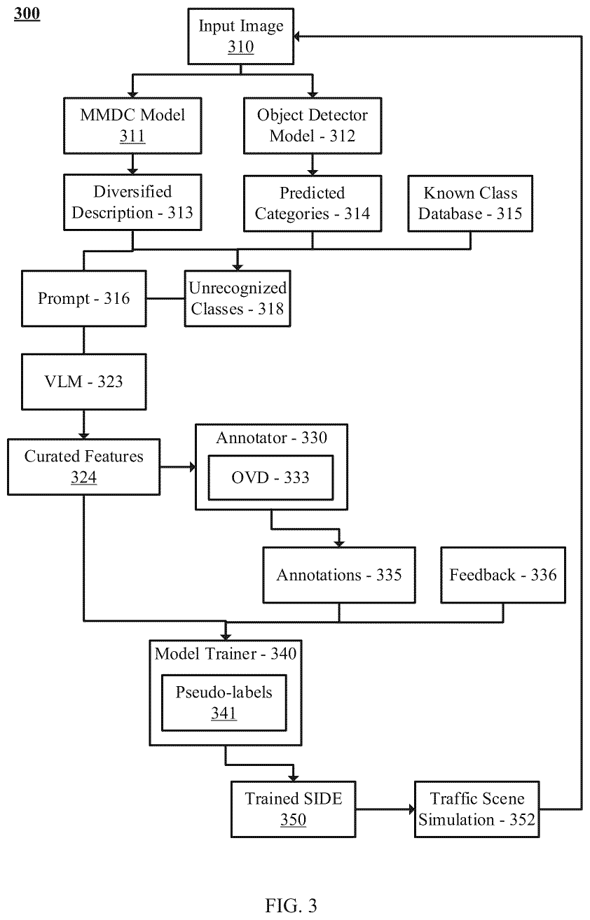

Referring now to FIG. 3, a block diagram illustrating an embodiment of a system showing a software implementation of a self-improving data engine for autonomous vehicles (SIDE).

The SIDE system 300 can include several particular software systems such as the MMDC model 311, object detector model 312, VLM 323, and OVD 333.

An input image 310 can be processed by MMDC model 311 to generate diversified description 313 and by the object detector model 312 to generate predicted categories 314. A known class database 315 can store and provide the known categories which the predicted categories 314 and the diversified description 313 can be compared against to detect unrecognized classes 318. The diversified description 313 that is relevant to the unrecognized classes 318 can be used to generate a prompt 316. In an embodiment, the known class database 315 can also be used to store prompt templates.

The prompt 316 can be fed to a VLM 323 to generate image features and textual features relevant to the unrecognized classes 318 to obtain curated features 324. The curated features 324 can be fed to an annotator 330 that can annotate the curated features 324 to include bounding boxes and labels by employing an OVD 333 to obtain annotations 335. The annotations 335, feedback 336 and curated features 324 can be used by a model trainer 340 to train the SIDE system 300 and obtain a trained SIDE 350. To retain previously learned knowledge, the model trainer 340 can generate pseudo-labels of known categories 341 and train with it and the new data.

The trained SIDE 350 can generate a new traffic scene simulation 352 that can be used as the next input image 310 in the next iteration of the continuous training of the SIDE system 300. After training, the SIDE system 300 can update the known class database 315 to include the newly learned classes that were previously unrecognized.

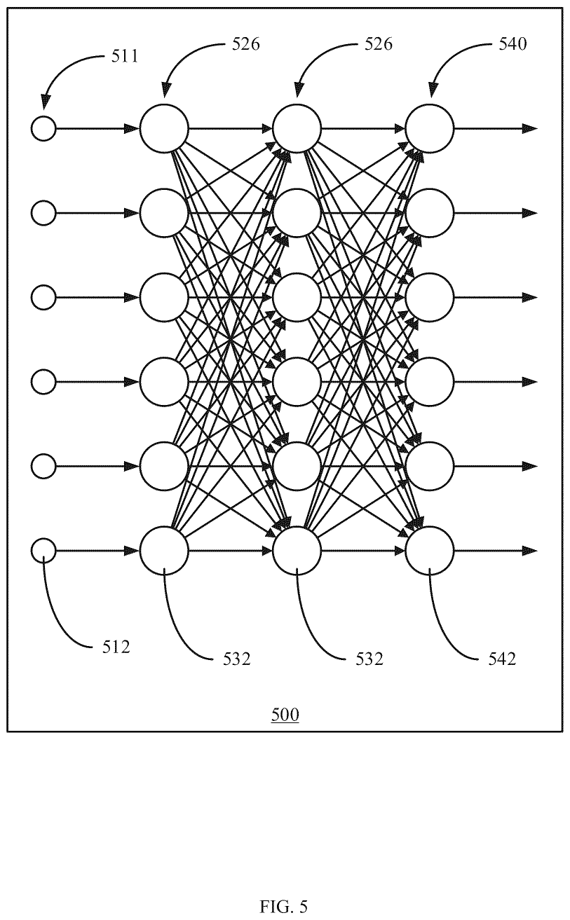

Referring now to FIG. 5, a block diagram illustrating deep learning neural networks for a self-improving data engine for autonomous vehicles, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 500, such as a multilayer perceptron, can have an input layer 511 of source neurons 512, one or more computation layer(s) 526 having one or more computation neurons 532, and an output layer 540, where there is a single output neuron 542 for each possible category into which the input example could be classified. An input layer 511 can have a number of source neurons 512 equal to the number of data values 512 in the input data 511. The computation neurons 532 in the computation layer(s) 526 can also be referred to as hidden layers, because they are between the source neurons 512 and output neuron(s) 542 and are not directly observed. Each neuron 532, 542 in a computation layer generates a linear combination of weighted values from the values output from the neurons in a previous layer, and applies a non-linear activation function that is differentiable over the range of the linear combination. The weights applied to the value from each previous neuron can be denoted, for example, by W₁, W₂, . . . Wₙ₋₁, Wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

In an embodiment, the computation layers 526 of the MMDC model 311 can learn relationships between embeddings of an image 314 and diversified descriptions 313 from an input image 310. The output layer 540 of the MMDC model 311 can then provide the overall response of the network as a likelihood score of relevance of the image 314 with the diversified description 313. In another embodiment, the object detection model 325 can identify associations between an input image 310 and object attributes within the input image 310 to predict categories. In another embodiment, the VLM 323 can generate photorealistic synthetic images that can include the unrecognized classes 318 from a prompt 316. In another embodiment, the OVD 333 can generate bounding box proposals and label proposals from curated features 324 to generate annotations 335. The OVD 333 can also generate pseudo labels 341 after another pass with the annotations along with some feedback 336.

Training a deep neural network can involve two phases, a forward phase where the weights of each neuron are fixed and the input propagates through the network, and a backwards phase where an error value is propagated backwards through the network and weight values are updated. The computation neurons 532 in the one or more computation (hidden) layer(s) 526 perform a nonlinear transformation on the input data 512 that generates a feature space. The classes or categories may be more easily separated in the feature space than in the original data space.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for training a self-improving data engine for autonomous vehicles (SIDE), comprising:
detecting unrecognized classes from diversified descriptions for input images generated using a multi-modality dense captioning (MMDC) model;
generating, with a vision-language-model (VLM), textual features from the diversified descriptions and image features from corresponding images to the diversified descriptions;
obtaining curated features, including curated textual features and curated image features, by comparing similarity scores between the textual features and top-ranked image features based on their likelihood scores;
generating annotations, including bounding boxes and labels, for the curated features by comparing the similarity scores of labels generated by a zero-shot classifier and the curated textual features; and
training the SIDE using the curated features, annotations, and feedback.

2. The computer-implemented of claim 1, further comprising generating trajectories within a traffic scene simulation to control an autonomous vehicle using the trained SIDE.

3. The computer-implemented method of claim 1, further comprising generating diverse traffic simulations using the VLM to verify that the trained SIDE can detect previously unrecognized classes.

4. The computer-implemented method of claim 3, wherein the diverse traffic simulations further includes new unrecognized classes to be detected by the trained SIDE.

5. The computer-implemented of claim 1, wherein generating the textual features and the image features further comprises generating photorealistic synthetic images that align with the textual features using a generative model.

6. The computer-implemented method of claim 1, wherein generating the annotations further comprises combining a base label space including the curated features with existing datasets to include objects likely present on road scenes for zero-shot classification.

7. The computer-implemented method of claim 1, wherein training the SIDE further comprises retaining previously learned knowledge by employing pseudo-labels for known categories to continuously train the SIDE.

8. A system for training a self-improving data engine for autonomous vehicles (SIDE), comprising:
a memory device;
one or more processor devices operatively coupled with the memory device to:
detect unrecognized classes from diversified descriptions for input images generated using a multi-modality dense captioning (MMDC) model;
generate, with a vision-language-model (VLM), textual features from the diversified descriptions and image features from corresponding images to the diversified descriptions;
obtain curated features, including curated textual features and curated image features, by comparing similarity scores between the textual features and top-ranked image features based on their likelihood scores;
generate annotations, including bounding boxes and labels, for the curated features by comparing the similarity scores of labels generated by a zero-shot classifier and the curated textual features; and
training the SIDE using the curated features, annotations, and feedback.

9. The system of claim 8, further comprising to generate trajectories within a traffic scene simulation to control an autonomous vehicle using the trained SIDE.

10. The system of claim 8, further comprising to generate diverse traffic simulations using the VLM to verify that the trained SIDE can detect previously unrecognized classes.

11. The system of claim 10, wherein the diverse traffic simulations further includes new unrecognized classes to be detected by the trained SIDE.

12. The system of claim 8, wherein to generate the textual features and the image features further comprises generating photorealistic synthetic images that align with the textual features using a generative model.

13. The system of claim 8, wherein to generate the annotations further comprises to combine a base label space including the curated features with existing datasets to include objects likely present on road scenes for zero-shot classification.

14. The system of claim 8, wherein to train the SIDE further comprises retaining previously learned knowledge by employing pseudo-labels for known categories to continuously train the SIDE.

15. A non-transitory computer program product comprising a computer-readable storage medium including program code for training a self-improving data engine for autonomous vehicles (SIDE), wherein the program code when executed on a computer causes the computer to:
detect unrecognized classes from diversified descriptions for input images generated using a multi-modality dense captioning (MMDC) model;
generate, with a vision-language-model (VLM), textual features from the diversified descriptions and image features from corresponding images to the diversified descriptions;
obtain curated features, including curated textual features and curated image features, by comparing similarity scores between the textual features and top-ranked image features based on their likelihood scores;
generate annotations, including bounding boxes and labels, for the curated features by comparing the similarity scores of labels generated by a zero-shot classifier and the curated textual features; and
training the SIDE using the curated features, annotations, and feedback.

16. The non-transitory computer program product of claim 15, further comprising to generate trajectories within a traffic scene simulation to control an autonomous vehicle using the trained SIDE.

17. The non-transitory computer program product of claim 15, further comprising to generate diverse traffic simulations using the VLM to verify that the trained SIDE can detect previously unrecognized classes.

18. The non-transitory computer program product of claim 15, wherein to generate the textual features and the image features further comprises generating photorealistic synthetic images that align with the textual features using a generative model.

19. The non-transitory computer program product of claim 15, wherein to generate the annotations further comprises to combine a base label space including the curated features with existing datasets to include objects likely present on road scenes for zero-shot classification.

20. The non-transitory computer program product of claim 15, wherein to train the SIDE further comprises retaining previously learned knowledge by employing pseudo-labels for known categories to continuously train the SIDE.
